(19) United States
(12) Patent Application Publication
(10) Pub. No.: US 2018/0276882 A1
(43) Pub. Date: Sep. 27, 2018

(54) SYSTEMS AND METHODS FOR AUGMENTED REALITY ART CREATION

(71) Applicant: PCMS Holdings, Inc., Wilmington, DE (US)

(72) Inventors: Tatu V. J. Harviainen, Helsinki (FI); Charles Woodward, Espoo (FI)

(21) Appl. No.: 15/542,748

(22) PCT Filed: Dec. 30, 2015
(86) PCT No.: PCT/US15/68087

§ 371 Date: Jul. 11, 2017

Related U.S. Application Data
(60) Provisional application No. 62/102,430, filed on Jan. 12, 2015.

(51) Int. Cl. G06T 17/10; G06T 19/00

(52) U.S. Cl. CPC G06T 17/10; G06T 19/006

(57) ABSTRACT

Systems and methods are described for generating and displaying augmented reality (AR) content. In an embodiment, a user captures a reference image of a scene using an AR device such as a headset or a tablet computer. The AR device automatically identifies 2D geometric features, such as edges, in the reference image. The user selects a 2D geometric feature and operates the AR device to generate a 3D geometric element by extrapolating the selected 2D feature into three dimensions using, for example, extrusion and lathe operations. The generated elements may be displayed by the AR device as an augmented reality overlay on the scene. The AR device may upload the generated elements to a networked content manager for sharing and viewing on the AR devices of other users.

### CROSS-REFERENCE TO RELATED APPLICATIONS

This application claims priority to and the benefit under 35 U.S.C. § 119(e) of U.S. Provisional Patent Application Ser. No. 62/102,430, filed Jan. 12, 2015 and entitled “Systems and Methods for Augmented Reality Art Creation,” the full contents of which are hereby incorporated herein by reference.

### FIELD

The present disclosure relates to augmented reality content creation and augmented reality content dissemination via social media channels.

### BACKGROUND

Augmented Reality (AR) aims at adding virtual elements to a user's physical environment. AR enhances our perception of the real world with virtual elements augmented on top of physical locations and points of interest. One of the most common uses for AR is simple visualization of virtual objects by means of 3-D computer generated graphics. Usually, virtual objects are produced by a 3-D modelling or scanning process, which makes extensive content production labor intensive. Often the content production required to manufacture meaningful virtual content for AR applications turns out to be the bottle neck, limiting the use of AR to a small number of locations and simple static virtual models. Visually rich virtual content seen in music videos and science fiction movies is not the reality of AR today because of the effort required for the production of dedicated 3-D models and their integration with physical locations.

In AR, content has traditionally been tailored for each specific point of interest, making the existing AR experiences limited to single use scenarios. As a result, AR is typically restricted to only a handful of points of interests. AR is commonly used for adding virtual objects and annotations to a view of the physical world, focusing on the informative aspects of such virtually rendered elements.

Computer graphics has become very active area for non-professional artists to practice their creative skills. Thanks to the lack of physical materials and studio space needed for digital art creation, digital sculptures, animation and paintings can be produced by anyone with access to a computer and time to invest in learning digital tools. However, with current tools, content creation is difficult to learn and time consuming to do, and there is little means for content distribution.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and to explain various principles and advantages of those embodiments.

FIG. 1 is a perspective view illustrating an example environment in which the system disclosed herein may be deployed, in accordance with an embodiment.

FIG. 2 illustrates a view as displayed on an exemplary client device of a captured image with highlighting of detected 2D features.

FIG. 3 illustrates a view as displayed on an exemplary client device of a captured image with illustration of 3D elements extrapolated from selected ones of the detected 2D features.

FIG. 4 illustrates a view as displayed on an exemplary client device of a captured image with illustration of 3D elements further extrapolated from selected ones of the detected 2D features. FIG. 4 further illustrates a view of a scene through an augmented reality device augmented by the 3D elements.

FIG. 5 is an illustration of an augmented reality client device in accordance with some embodiments.

FIG. 6 is a flow diagram illustrating a method of generating a 3D element for display by an augmented reality system.

FIG. 7 is a flow diagram illustrating a method of retrieving a 3D element for display by an augmented reality system.

FIG. 8 is a functional block diagram illustrating an exemplary architecture for generating, sharing, and displaying 3D elements extrapolated from 2D image features.

FIG. 9 is a schematic block diagram illustrating the components of an exemplary wireless transmit/receive unit that may be used as a client device in some embodiments.

FIG. 10 is a schematic block diagram illustrating an exemplary network entity that may be used to implement an augmented reality cloud service in some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The systems and processes disclosed herein enable users to generate three dimensional (3-D) augmented reality (AR) content and disseminate their creation(s) to other users via social media channels. Using systems and methods disclosed herein, AR can be used to output abstract content with a goal of enhancing a mood and atmosphere of a space and context a user is in.

In an exemplary use case, a user employs a mobile device that includes an image sensor to capture a two-dimensional (2D) image of a scene. By using a live viewfinder (e.g., displaying a video stream of what the image sensor detects) the user can see what is being captured by the image sensor in real time. When the user decides he wants to use a certain view (e.g., scene or image) he may select that view as a marker image. At this point the live camera feed pauses and the user works with the selected 2D marker image. Image analysis is used to identify one or more geometric image features (e.g., contour lines and geometric primitives such as squares, circles, ellipses, rectangles, triangles, etc.). In some embodiments this image analysis is aided by user input, for example identifying corners of various geometric primitives. In at least one embodiment, the user selects which geometric image features should be used for generating the 3D elements and discards those that are not of interest. In at least one embodiment, the geometric image features are selected with the aid of image processing software. The display resumes showing the live feed from the image sensor, but at this point the identified geometric image features can be mapped or synchronized to this live feed. 3D elements are generated based at least in part on the identified geometric image features and are overlaid on the live feed. This process can be done with or without the help of user input. In some cases, random or semi-random iterative generation approaches are used to generate the 3D content from the identified geometric image features. In some cases, user input helps to control the generation process. The user may modulate these 3D elements via various forms of user input.

The mobile device may be implemented using a smartphone, a smart-glass headset, a virtual reality headset, or an augmented reality headset, among other examples. The display may be a head-mounted display, and the display may be optically transparent.

The image sensor may include one or more of a depth sensor, a camera sensor, or a light field sensor.

In at least one embodiment, the user input is a touch sensor input. In at least one embodiment, the user input is a gesture input.

The mobile device may further include one or more of a touch-input sensor, a keyboard, a mouse, a gesture detector, a GPS module, a compass, a gyroscope, an accelerometer, a tilt sensor and a barometer. The modulation of the 3D elements may further be based on data received from one or more of these elements.

In some embodiments, the process further comprises tracking the mobile device relative to its environment to determine a relative position, orientation, and movement of the mobile device. In at least one embodiment, tracking the mobile device comprises using the image sensor to detect the relative position, orientation, and movement of the mobile device.

One or more sensors selected from the group consisting of a depth sensor, a light field sensor, a GPS module, a compass, a gyroscope, an accelerometer, a tilt sensor and a barometer, may be used to help determine the relative position, orientation, and movement of the mobile device.

In at least one embodiment, overlaying the generated 3D elements on the video stream via the display includes using the relative position, orientation, and movement of the mobile device to align the generated 3D elements with the video stream. The generated 3D elements may be aligned with a real world coordinate system based on viewpoint location data and orientation data calculated by 3D tracking.

In at least one embodiment, the video stream undergoes one or both of post-processing and filtering. Overlaying the generated 3D elements on the video stream via the display includes combining the modulated 3D elements with post-processed or filtered video stream on the display.

In at least one embodiment, the modulated 3D elements are post-processed or filtered before being overlaid on the video stream.

The generation of 3D elements using the identified geometric image features may be performed at least in part by the use of an iterated function system (IFS) and/or a fractal approach.

In at least one embodiment, the geometric image features include a contour segment. In such an embodiment, generating 3D elements can include transforming the contour segment into 3D geometry using a lathe operation. In at least one such embodiment, generating 3D elements includes transforming the contour segment into 3D geometry using an extrude operation.

In at least one embodiment, the geometric image features include a basic geometric primitive. In at least one such embodiment, generating 3D elements includes extrapolating the basic geometry primitive from 2D to 3D.

In some embodiments, a user points the image sensor towards a desired scene. The image sensor generates a video stream of planar 2D images that the user wishes to use and this data will be output to a display, which shows a live view of the scene captured by the image sensor. The user selects a marker image, and the live view is frozen on the marker image. This stops the live view so that the user may temporarily work with a planar 2D image. The marker image acts as a starting point for the content creation. One or more 2D geometric image features of the marker image are detected image analysis software. If needed, the user identifies one or more geometric image features of the marker image to identify for the image marker extraction algorithm exactly what area to process. In some cases, this step may involve the user selecting corners of geometric primitives in the marker image. To enhance the quality of 3D AR content creation and modulation, an image marker quality algorithm analyzes the image and defines whether the proposed marker image includes clear enough geometric features so that the geometric features can be used for object tracking and image synchronization. Because generated 3D content is to be overlaid on a live view from the image sensor, the geometric features in the marker image are used to align the 3D content with the live view. If the marker image is usable for the 3D content creation, the user proceeds to the 3D content production phase described in the following paragraphs.

In some embodiments, one or more of the identified geometric image elements may be deleted so that they are not used for the 3D content generation.

At least one embodiment includes sharing the generated 3D content via social media channels. A link to the 3D content may be shared along with a 2D image of the generated 3D content. The generated 3D content may be uploaded to a database.

Embodiments disclosed herein may be implemented using a mobile device having an image sensor, a display, a processor, and data storage containing instructions executable by the processor for carrying out a set of functions. The set of functions includes receiving a video stream of image frames from the image sensor and viewing the video stream on the display, selecting a marker image, wherein the marker image is one of the image frames, pausing the video stream at the marker image, identifying one or more 2D geometric image features present in the marker image, resuming the video stream of image frames from the image sensor, generating 3D elements at least in part by extrapolating the identified 2D geometric image features present in the marker image, overlaying the generated 3D elements on the video stream via the display, and modulating the 3D elements based at least in part on a user input.

One embodiment takes the form of a system that includes (i) a cloud service that includes a content database, a content manager, a download application programming interface (API), and an upload API, (ii) an augmented reality (AR) application that includes an AR viewing application in communication with the download API and an AR authoring application in communication with the upload API, and (iii) at least one social media API, wherein each social media API is in communication with the AR authoring application.

In at least one embodiment, 3D content is generated using the AR authoring application and is uploaded to the content database via the upload API. The uploaded 3D content may include metadata in the form of one or more of a location and a set of geometric image elements used for the generation of the 3-D content.

In some embodiments, a user can access generated 3D content that is stored on the content database using the AR viewing application via the download API. A user can access metadata associated with generated 3-D content that is stored on the content database using the AR viewing application via the download API.

A user may disseminate access to generated 3-D content using social media channels via a social media API.

Some embodiments take the form of a method carried out by a mobile device having an image sensor, and a display. The method comprises receiving a video stream of image frames from the image sensor and viewing the video stream on the display, selecting a marker image, wherein the marker image is one of the image frames, identifying one or more 2D geometric image features present in the marker image, generating 3D elements at least in part by extrapolating the identified 2D geometric image features present in the marker image, and overlaying the generated 3D elements on the video stream via the display.

Identifying one or more geometric image features present in the marker image may include a user identifying one or more geometric image features present in the marker image via a user interface. Identifying one or more geometric image features present in the marker image may include image analysis software identifying one or more geometric image features present in the marker image. In at least one embodiment, a user can select, amongst the one or more identified geometric image elements, a subset of the identified geometric image elements that are to be used for generating 3D elements. The subset may be selected via a user interface.

3D content is generated based on the marker image. The marker image is analyzed in order to extract distinctive shapes, area segments, outline segments and associated colors (geometric image features). Extracted shapes and segments are extrapolated into 3D geometry with geometric operations familiar from 3D modelling software such as extrude and lathe, and 3D shape matching, such as turning detected rectangles into cubes, ellipsoids into spheres, etc. Generated geometry in some embodiments is grown and subtracted during the run-time procedurally, combining basic shapes iteratively in order to grow increasingly complex compilation of 3-D geometry. Colors for the generated 3D elements are picked from the 2D image. This content creation may be accomplished automatically or with the aid of a user input. During the generation of 3D elements, the user can control the process by pointing and by manipulating 3D geometry elements. Depending on the device platform, the input gestures are detected from touch screen manipulation, direct hand gestures or other user controlled input means. More details about the interaction styles are explained in the context of various embodiments in later paragraphs.

Data processing for detecting 2D features such as geometric primitives and contour segments can be achieved with known image processing algorithms. For example, OpenCV features powerful selection of image processing algorithms with optimized implementations for several platforms and it is often the tool of choice for programmable image processing tasks.

Procedural geometry techniques are used in some embodiments for generation of 3D elements from 2D image features. Techniques that may be used for generating procedural content include noise (Perlin, K., “An image synthesizer”. In Computer Graphics (Proceedings of ACM SIGGRAPH 85), ACM, 287-296, 1985); fractals (Mandelbrot, B., “Fractale: Form, Chance and Dimension”. W.H. Freeman and Co. 1977); and L-systems (Prusinkiewicz, P., Lindenmayer, A., Hanan, J. S., Fracchia, F. D., Fowler, D. R., De Boer, M. J., Mercer, L., “The Algorithmic Beauty of Plants”. Springer-Verlag, 1990). A comprehensive overview of the procedural methods associated with 3-D geometry and computer graphics in general is found in Ebert, D. S., ed., “Texturing & modeling: a procedural approach”. Morgan Kaufmann, 2003. For 3-D geometry generation suitable for this use case, iterated function systems (IFS) is another suitable approach.

IFS is a method for creating complex structures from simple building blocks by iterative combinations that repeatedly apply a set of transformations to the results of previous iterations. Resulting 3D geometry achieved with this approach tends to have a repetitive self-similar and organic appearance. In the context of this disclosure, the simple building blocks are the basic 2D features shapes identified in the marker image extrapolated to 3D elements from the image analysis, as well simple 3-D shapes created by simple lathe and extrusion of clear image contour lines, also achieved from the image analysis. These building blocks are iteratively combined with random or semi-random transformation rules.

In some embodiments, a cloud storage service is used to store AR content created by the user and associated metadata. This metadata may include information on where the 3D AR content was created (geotagging) and the identified geometric image features that were used during the 3-D content generation procedure. In some embodiments, generated AR content is also stored locally at the mobile device as a backup. A server-side implementation of the storage system generates preview images and location information for the user which may be used on messages posted via various social media channels. For viewers, the cloud storage service provides information about the AR content available. This information may be provided based on a viewing user's location and his proximity to previously generated AR content, as well as associated image markers detected by a viewing user device's image sensor.

In an exemplary embodiment, users can see published messages about novel AR content through various social media channels. Messages may provide 2D still image renderings of the created AR content as well as location information and information about the overall service and associated mobile application. Viewing users who have installed a viewer application on their mobile device can inspect their environment via their device's image sensor and see all the AR content in the surrounding area that has been generated by other users. The viewing is based on the identified geometric features and metadata content provided by the cloud storage service.

Automatic content creation may be performed by creating virtual geometry from the visual information captured by a device camera or similar sensor and by post-processing images to be output to a device display. Virtual geometry is created by forming complex geometric structures from geometric primitives. Geometric primitives are basic shapes and contour segments detected by the camera or sensor (e.g., depth images from a depth sensor). The virtual geometry generation process includes building complex geometric structures from simple primitives.

Data processing for detecting geometric primitives and contour segments can be achieved with well-known image processing algorithms. For example, OpenCV features a powerful selection of image processing algorithms with optimized implementations for several platforms. Image processing algorithms may be used to process depth information as well. Depth information is often represented as an image in which pixel values represent depth values.

Some embodiments employ procedural geometry techniques such as noise, fractals and L-systems. A comprehensive overview of the procedural methods associated with 3-D geometry and computer graphics in general may be found in Ebert, D. S., ed., “Texturing & modeling: a procedural approach”. Morgan Kaufmann, 2003.

Those with knowledge and skill in the relevant art are aware of methods for constructing virtual representations of a 3D space from a set of 2D images. This technique is generally known as 3D reconstruction. However, in embodiments disclosed herein, full 3D reconstruction or identical representation of the created 3-D virtual space is not required. In general, modeling can be done by using geometric primitives and textures which can be extracted from the images.

At least one embodiment takes the form of a process carried out by head-mounted optically or electronically transparent display system. The head-mounted transparent display system includes a processor, memory and is associated with at least one image sensor. The process includes a user selecting at least one synchronization input. The synchronization input may be a selected song or ambient noise data detected by a microphone. The synchronization input may include other sensor data as well. The image sensor provides input images for virtual geometry creation. The audio signal selected for synchronization is analyzed to gather characteristic audio data such as a beat and a rhythm. According to the beat and rhythm, virtual geometry is overlaid on visual elements detected in the input images. For example, simple elements may start to grow into complex virtual geometry structures). The virtual geometry may be animated to move in sync with the detected audio beat and rhythm. Distinctive peaks in the audio cause visible events in the virtual geometry. In some embodiments, image post processing is actively used in synchronization with the audio rhythm to alter the visual outlook of the output frames. This can be done by changing a color balance of the images and 3-D rendered virtual elements, adding one or more effects such as bloom and noise to the virtual parts, and color bleed to the camera image.

Another embodiment takes the form of a device with a sensor that provides depth information in addition to a camera that provides 2D video frames. Such a device set-up may be, for example, a smart glasses system with an embedded depth camera. These devices carry out a process. The process, when utilizing the depth data, can modulate a more complete picture of the environment in which the device is running. With the aid of depth information, some embodiments operate to capture more complex pieces of 3D geometry from the scene and use them to create increasingly complex virtual procedural geometry. For example, using the depth information, the process can operate to segment out elements in specific scale, and the system can use the segmented elements directly as basic building blocks in the procedural geometry creation. With this approach, the process can, for example, segment out coffee mugs on the table and start procedurally creating random organic tree like structures built from a number of similar virtual coffee mugs.

Furthermore, having comprehensive depth information available improves 3D tracking of the camera movements and enable more seamless integration of virtual elements to the camera image. For example, occlusions and shadows caused by the physical elements can be accounted for. Relations between virtual and physical elements are more accurately detected due to depth information.

In exemplary embodiments, image data from a device image sensor is captured and used for 3D camera tracking and for detection of geometric image features that are used for the generation of 3D elements. Generated virtual geometry is overlaid on the AR physical world based on the 3D camera tracking.

3D geometric elements are generated based on the input elements selected from the visual input. Visual input data is analyzed in order to extract distinctive 2D features such as shapes and contour segments. Extracted shapes and contour segments are extrapolated to 3D geometry with geometric operations familiar from 3D modelling software such as extrude and lathe, or 3D primitive (box, sphere, etc.) matching. In some embodiments, generated geometry is grown and subtracted during the run-time with fractal and random procedures.

In addition to the virtual 3D geometry augmentation, image post-processing can be added to the output frames before displaying them to the user. These post-processing effects can be filter effects to modify the color balance of the images, distortions added to the images and the like.

Both (i) parameters for the 3-D element generation and (ii) parameters for image post processing can be modified during the process run-time in synchronization with user and sensor inputs.

The process described herein includes receiving an input video stream from an image sensor (e.g., a camera). The process may also include tracking camera movements. In this example, the tracking utilizes image data received from the camera. The process also includes identifying one or more contour segments, primitive shapes, or other characteristic geometric elements in the input video stream. A selected subset of these elements is used to generate one or more 3D elements. Generating one or more 3D geometric elements may include applying a lathe or extrude function on at least one of the elements in the subset. Generating 3D geometric elements may include employing fractal methods. The process may also include identifying a display position for the generated 3D geometric element based at least in part on the tracked camera movements. This enables the system to precisely overlay the generated 3D content on the environment. The process further includes dynamically adding, removing, modulating, and modifying the generated 3D geometry in response to user and sensor input. The process may include adding, removing, modulating, and modifying post-processing and visual effects to the video frames. The process also includes combining the processed video frames with the generated 3D geometry. This combined video is output to a display device. This generated content can be shared via various social media channels. The generated content can be uploaded to a cloud computing device (e.g., a content database).

In at least one embodiment, data from an image sensor is analyzed. Image sensor input (i.e., individual frames from the 2D or 3D image sensor) and various other sensor inputs may be analyzed for at least two purposes.

A first purpose is for 3D tracking of the sensor's point of view (which may be the user's point of view). 3D tracking is used for maintaining the relative sensor position and orientation relative to the sensed environment. With the sensor orientation and position resolved by a tracking algorithm, the content to be displayed can be aligned in a common coordinate system with the physical world. As result, 3D geometry maintains orientation and location registration with the real world as the user moves, creating an illusion of generated virtual geometry being attached to the environment. 3D tracking can be achieved by many known methods, such as SLAM (simultaneous localization and mapping) and any other sufficient approach.

A second purpose of the image sensor analysis is to generate input for the 3D element creation. In at least one embodiment, a user input can be used to control the creation of content and animation of previously-created content. This creates a connection between external events and virtual content. Other signals, such as motion sensor data, can be used for contributing to the creation and animation of the generated 3D elements. In some embodiments, appropriate signal analysis for various different types of signals is used.

In at least one embodiment, a content-control-event creation involves using various analysis techniques to generate controls for the creation and animation of the generated 3D elements. Content-control-event creation can utilize at least one or more of the signal processing techniques described above, user behavior and context information. Sensors associated with the device can include inertial measuring units (e.g., gyroscope, accelerometer, compass), eye tracking sensors, depth sensors, and various other forms of measurement devices. Events from these device sensors can be used directly to impact the creation of the generated 3D elements, and sensor data can be analyzed to get deeper understanding of the user's behavior. Context information, such as event information (e.g., at a music concert) and location information (e.g., on the golden gate bridge), can be used for tuning the style of the generated 3D elements, when such context information is available.

In at least one embodiment, generated 3D content is generated with procedural methods and is based, at least in part, on visual elements of detected environmental geometry. In at least one embodiment, the method identifies clear contours, contour segments, well-defined geometry primitives, such as circles, rectangles and the like, and uses these detected 2D features to generate 3D geometric elements. Individual contour segments can be extrapolated into 3D geometry with operations such as lathe and extrude, and detected basic geometry primitives can be extrapolated from 2D to 3D, e.g. a detected square shape to a virtual box and circle to a sphere or cylinder. In some embodiments, wherein a depth sensor is employed, reconstructing environment geometry can be replaced with a shape filling algorithm using other 3D objects. The sensed geometry can be warped and transformed.

The new 3D geometry may be created with a fractal approach. Fractals are iterative mathematical structures, which when plotted to 2D images, produce an infinite level of varying details. A famous example of fractal geometry is the bug-like figure of classic Mandelbrot set, named after Benoit Mandelbrot, developer of the field of fractal geometry. A Mandelbrot series is a set of complex numbers sampled under iteration of a complex quadratic polynomial. As complex numbers are inherently two dimensional, mapping values to real and imaginary parts in a complex plane, this classical fractal approach is one example approach for creating 2D visualizations. Although there are some approaches for extending classical fractal formulas to three dimensions, such as Mandelbud, there exist other approaches available for creating 3D geometry in similar manner, which still enable the creation of complexity from simple starting conditions (e.g. audio input data and visual input data and the results of their analysis).

Iterated function system (IFS) is a method for creating complex structures from simple building blocks by applying a set transformations to the results of previous iterations. 3D geometry achieved with this approach tends to have a repetitive self-similar and organic appearance. In at least one embodiment, an IFS is defined using (i) the detected 2D geometric features, which are extrapolated to 3D elements, as well as (ii) simple 3D shapes created by lathe and extrusion operations of clear image contour lines. These building blocks are iteratively combined with random or semi-random transformation rules. This is an approach which is used in commercial IFS modelling software such as XenoDream. Ultra Fractal is another fractal design software, with more emphasis on 2D fractal generation.

In at least one embodiment, the virtual geometry creation is done during run-time. According to temporal rules set for the execution, basic virtual geometry building blocks are created from the analyzed visual input. With timing set by a control signal, basic building blocks are embedded within the user's view and the basic building blocks will start to grow more complex by adding IFS iterations according to temporal rules set by the control signal. Once the structure created by IFS reaches certain complexity level, parts of it may start to disappear, again according to timing set by the control signal. In addition to dynamic temporal growing and dying of IFS structures, the elements are animated by adding dynamic animation transformations to the elements. The animation motion is controlled by the control signal in order to synchronize the motion with the user input or any other signals which are used as synchronization input.

In at least one embodiment, the generated virtual 3D geometry is aligned with a real world coordinate system based on viewpoint location data and orientation data calculated by the 3D tracking step. Viewpoint location and orientation updates are provided by the 3D tracking which enables virtual content to maintain location match with the physical world. Output images are prepared by rendering the image sensor data in the output buffer background and then rendering the 3D geometry on top of the background texture. Output images can be further post-processed in order to add further digital effects to the output. Post-processing can be used to add filter effects to alter the color balance of the whole image, alter certain color areas, add blur, noise, and the like.

In at least one embodiment, produced output images are displayed on a display of a viewing device. The display can be, for example, a mobile device such as smart phone, a head mounted display with optically transparent viewing area, a head-mounted augmented reality system, a virtual reality system, or any other suitable viewing device.

In at least one embodiment, the user can record and share the virtual experiences that are created. For recording and sharing, a user interface is provided for the user, with which he or she can select what level of experience is being recorded and through which channels and with whom it is shared. It is possible to record just the settings (e.g., image post processing effects and geometry creation rules employed at the moment) for at least the reason that people with whom the experience is shared with can have the same interactive experience. For sharing the complete experience with all the events and the environment of the user, the whole experience can be rendered as a video, where audio and virtual elements, as well as post processing effects, are all composed to a single video clip, which then can be shared via existing social media channels.

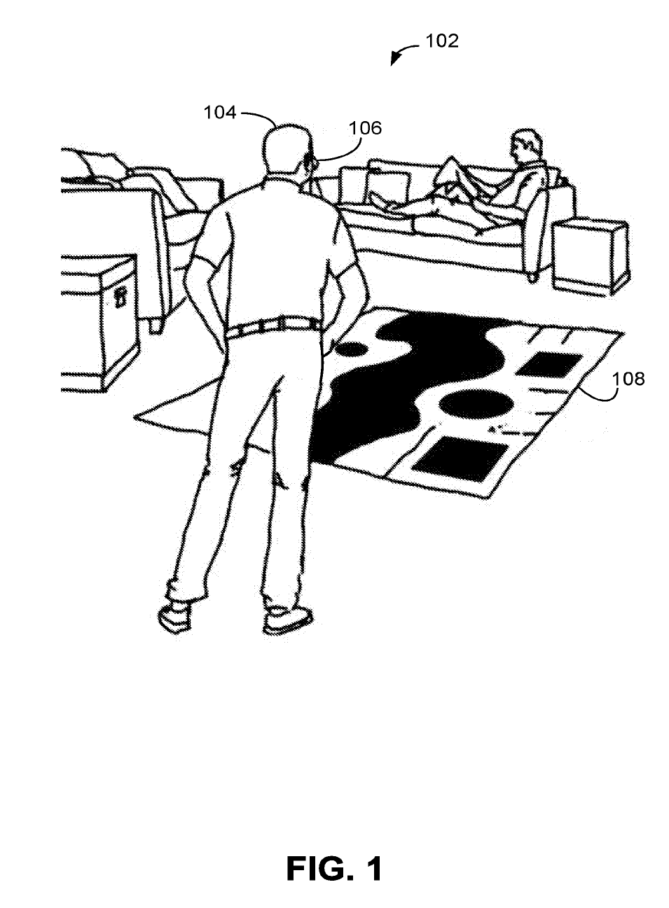

FIG. 1 depicts an example scenario, in accordance with at least one embodiment. In particular, FIG. 1 depicts a room 102 that includes a user 104 wearing a video see-through AR headset 106. The user 104 is looking through the AR headset 106 at a rug 108. The rug 108 includes patterns which may be detected as 2D geometric features by the systems and processes disclosed herein. A video stream is captured by the AR headset and output to the video see-through display 106. The user selects an image to capture as a marker image. The user is looking at the rug 108 on the floor which includes colorful patterns and shapes.

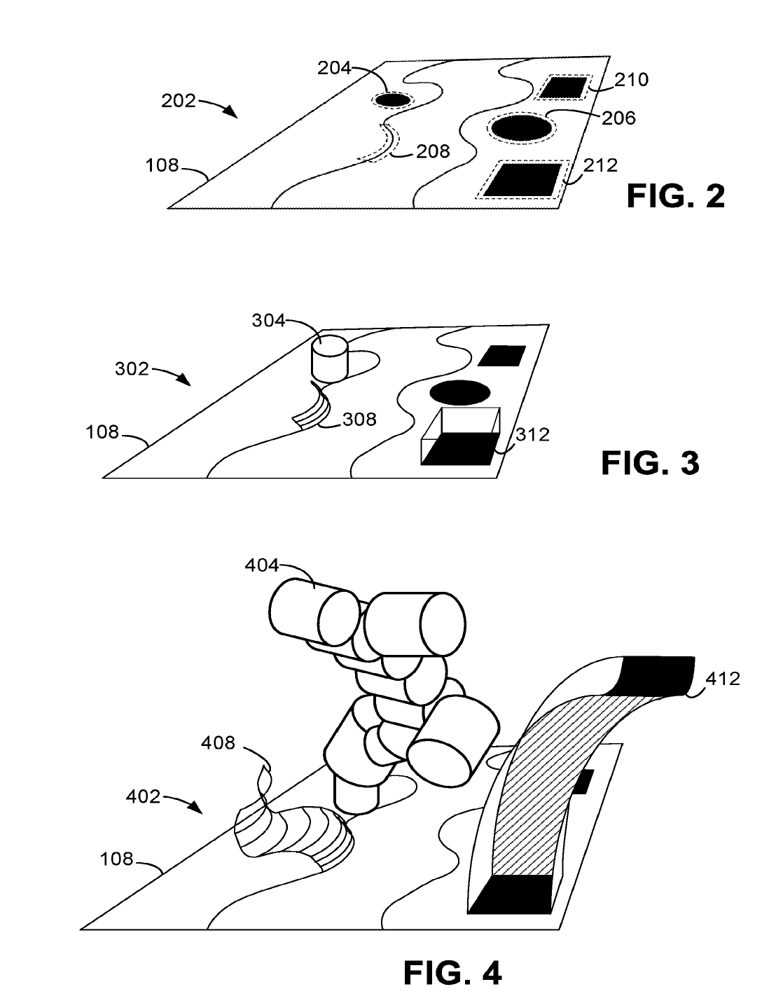

In this example, the user selects a still image of the rug 108, such as the image 202 illustrated in FIG. 2, as a marker image. Image processing is performed on the marker image to detect one or more 2D geometric features, such as curves, edges, and geometric primitives 204. These features are highlighted on the display of the AR device, as illustrated in FIG. 2. In this example, ellipses 204 and 206, edge curve 208, and polygons 210 and 212 have been detected and highlighted.

In an exemplary embodiment, highlighted 2D features displayed on a display of the augmented reality device identify those features that may be selected by a user for generation of 3D elements. These features may be selected (and deselected) by, for example, interaction with a touch screen, through gesture recognition, or through the use of other input techniques.

FIG. 3 illustrates the extrapolation of 2D features into 3D geometric elements as displayed on a display of an augmented reality device. In the example of FIG. 3, ellipse 204 of FIG. 2 has been extrapolated into a cylinder 304, curve 208 has been extrapolated into a surface 308, and polygon 312 has been extrapolated into polyhedron 312. The extrapolation process may be initiated by, for example, a user selecting a highlighted 2D feature and dragging (e.g. on a touchscreen) in a selected direction to extrude the 2D feature. Other input techniques are described in greater detail below.

FIG. 4 illustrates a further outcome of extrapolation of 2D features into 3D geometric elements. Cylinder 304 from FIG. 3 has been further extrapolated to generate 3D geometric element 404. The generation of element 404 may be performed using, for example, procedural geometry techniques such as copying and transformation of cylinder 304 in random or predetermined directions. Surface 308 has been further extrapolated into surface 408, and polyhedron 312 has been further extrapolated into 3D element 412.

The 3D elements generated using the techniques illustrated in FIGS. 2-4 may be uploaded to a cloud server along with content metadata. The elements may be uploaded using various available techniques for representing 3D geometric elements, such as, for example, polygon mesh technique, non-uniform rational B-spline techniques, or face-vertex mesh techniques. Other users can access this generated content over a network. Additionally, the content may be shared with others via social media channels.

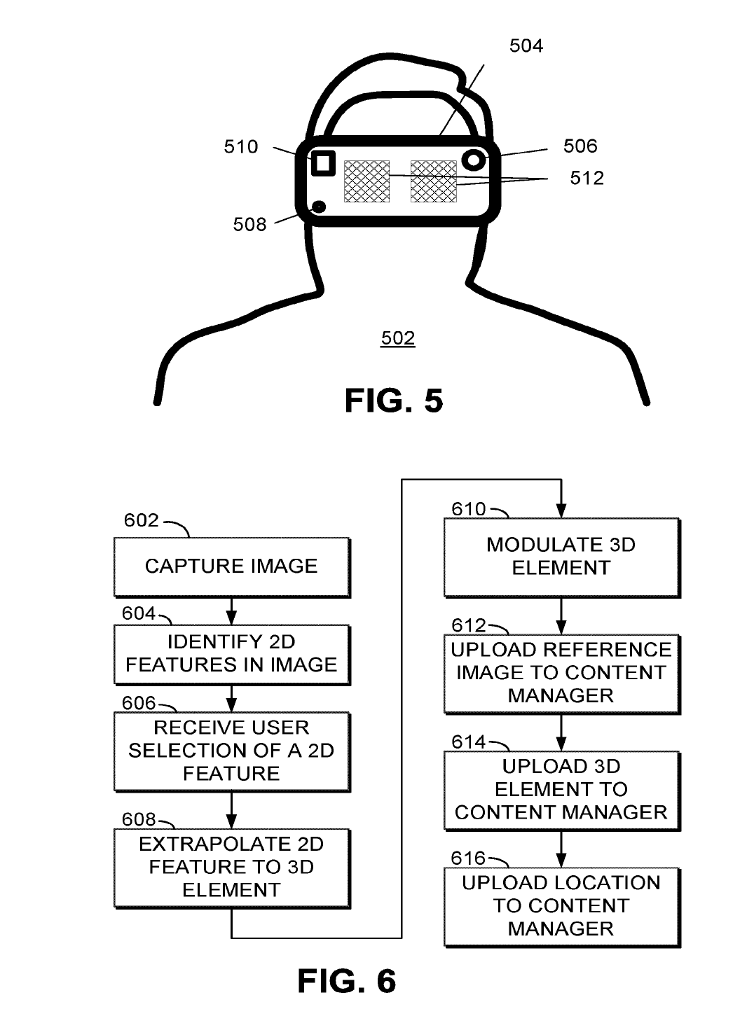

In some embodiments, the systems and methods described herein may be implemented in an AR headset, such as AR headset 504 of FIG. 5. AR headset 504 may be an optical see-through or video see-through AR headset. FIG. 5 depicts a user wearing a VR headset, in accordance with at least one embodiment. In particular, FIG. 5 depicts a user 502 wearing a VR headset 504. The VR headset 504 includes a camera 506, a microphone 508, sensors 510, and a display 512. Other components such as a data store, a processor, a user interface, and a power source are included in the VR headset 504, but have been omitted for the sake of illustration. The camera 506 may be a 2D camera, or a 3D camera. The microphone 508 may be a single microphone or a microphone array. The sensors 510 may include one or more of a GPS, a compass, a magnetometer, a gyroscope, an accelerometer, a barometer, a thermometer, a piezoelectric sensor, an electrode (e.g., of an electroencephalogram), and a heart-rate monitor. In embodiments in which the display 512 is a non-optically-transparent display, a video combiner may be utilized so as to create a view of the present scene overlaid with the modulated virtual elements.

In some embodiments, a user generates content with the use of AR content authoring software. The user captures a marker image, and 2D features in the marker image, such as edges and geometric shapes, are manually or automatically detected. The user selects, deselects, and/or moves identified 2D features and extrapolates one or more of those 2D features to generate a 3D geometric element. Once user is satisfied with the results, created content with associated metadata and marker image are uploaded to the AR cloud service, which is a server side AR content management service for this system. When data is uploaded, the artist can send messages via social media channels about the created content. For social media channels, still images of the new content augmented on top of marker image are generated, and associated location information is attached to the generated messages.

Other users can find information about the novel content from social media, in the form of status updates, tweets, personal messages and the like that the artist has posted on-line with the help of the AR content creation service. From the messages, viewer is provided with a link to additional information and AR application (e.g., AR viewing software) installation.

Users with the AR application installed can use the application to view images added to the service as markers and to see the content created as real-time augmentations. Based on the approximation of the user location, marker images in that area are loaded to the viewer application. When marker images are detected from the camera view of the viewer's display device, associated content is downloaded from the service and augmented.

In general, the artist can share his AR content with viewers directly through use of the social network APIs and the artist can upload the content to the content database through use of the upload API.

Selection of a marker image and identification of 2D features in the marker image may be performed in various ways. In some embodiments, a mobile device receives a video stream from an image sensor. The video stream is output of a display of the mobile device. The user selects a marker image to be used as the canvas for 3D AR content generation. The device identifies one or more 2D geometric image features present in the marker image. In some embodiments, this accomplished with the help of user input. For example, the user may identify the corners of a rectangle by using a touchscreen of the mobile device.

In another exemplary embodiment, after a user selects a marker image, one or more 2D geometric image features (such as contour or edge lines) are automatically identified using image processing software. The user may select, de-select, and/or delete identified image features. Deleting a feature may be performed by, for example, swiping the unwanted feature off the display. Of course, various other means for selecting and deselecting (removing, deleting, etc.) identified geometric image elements could be implemented as well.

Generated 3D elements may be displayed on the video stream via the display and may be modulated based at least in part on a user input. For example, a user may use drag or pinch inputs to modulate generated 3D elements. A pinch input (two-finger touch) may be used to resize generated 3D elements. A drag input may be used for copying, extrusion, and the like. In some embodiments, user gestures are employed to extrapolate 2D features into 3D elements and to modulate 3D elements. For example, a user provided with an AR headset may provide input using hand or arm gestures that are detected by a forward-facing camera of the AR headset.

In general, user input can be used to help identify, select and deselect geometric image elements. User input can also be used for modulating generated 3D content. Control of various applications (e.g., AR authoring software and AR viewing software) and UI elements can be accomplished through use of user input as well.

An exemplary content generation method is illustrate in FIG. 6. In step 602, a marker image is captured using a client device. The marker image may be represented as, for example, a two dimensional array of pixels. In step 604, one or more 2D features are automatically detected in the marker image. As an example, an edge detection technique such as the Canny edge detector, the Deriche edge detector, differential edge detection, Sobel edge detection, Prewitt edge detection, or Roberts cross edge detection may be used to detect one or more 2D edges appearing in the marker image.

In step 606, a user selects at least one of the detected 2D features. For example, a user may select a particular curve detected through edge detection by touching the curve on a touch screen of the mobile device.

In step 608, the selected 2D feature is extrapolated into a 3D geometric element. This may be done in a variety of different ways, as described in greater detail below.

In some embodiments, the two-dimensional marker image is mapped to a two-dimensional plane embedded within a three-dimensional coordinate system that represents the user's physical surroundings. For example, the AR authoring module may define a coordinate system (x,y,z) representing each point in the three-dimensional space at the user's location, and each pixel in the marker image may be identified by two-dimensional coordinates (p,q). Then, in this example, the AR authoring module performs a mapping M: (pᵢ,qᵢ)→(xᵢ,yᵢ,zᵢ) for all values of (pᵢ,qᵢ). The mapping may be a linear mapping, such as multiplication by a rotation matrix, scaling, and addition of an offset vector. The mapping may be determined at least in part by user or sensor input. For example, an accelerometer, magnetometer, GPS, and/or other sensors may be employed to determine the location and orientation of the client device when the marker image is captured. If the client device was held in such a way that the marker image was captured while the camera of the client device was vertical and facing directly forward, then the mapping M may be selected such that pixels (pᵢ,qᵢ) are mapped to a vertical surface in the coordinate system (x,y,z), e.g. pixels (pᵢ,qᵢ) may be mapped to points in the (x,z) plane, the (y,z) plane, or other plane parallel to the z axis, with appropriate level of scaling. If, on the other hand, the camera is detected to be pointed downward when the marker image is captured, the pixels (pᵢ,qᵢ) may be mapped to points in the (x,y) plane. It will be evident in view of this disclosure that different camera orientations can be accommodated by mapping to different planes with corresponding orientations. In some embodiments, pixels may be mapped to non-planar surfaces. In some embodiments, mapping of pixels to surfaces in the 3D coordinate system may be conducted with user input instead of or in addition to sensor input.

Thus, the mapping M from a two-dimensional pixel-based coordinate system to a three-dimensional coordinate system representing the user's environment results in some embodiments in a set of points {(x₁,y₁,z₁), (x₂,y₂,z₂) . . . (xₙ,yₙ,zₙ)} that represents the mapping of the detected 2D feature into the 3D coordinate system. The detected 2D feature may be extrapolated into a 3D geometric element using one or more of several different techniques. The technique used to extrapolate the detected 2D feature may be selected by the user (e.g. from a menu) or may be determined automatically (e.g. randomly or according to a predetermined algorithm that is selected to generate visually pleasing results).

In one technique of extrapolating a 2D feature to 3D, the detected 2D feature is expanded. For example, the set of points {(x₁,y₁,z₁), (x₂,y₂,z₂) . . . (xₙ,yₙ,zₙ)} may be extrapolated to a 3D element by generating anew set of points {(x′₁,y′₁,z′₁), (x′₂,y′₂,z′₂) . . . (x′ₚ,y′ₚ,z′ₚ)} such that every point (x′ᵢ,y′ᵢ,z′ᵢ) is within a distance r, of at least one point (xⱼ,yⱼ,zⱼ) of the 2D feature. The distance r may be provided by a user input. For example, a user may use a text input or a pinch input to increase or decrease the value of r. Such an extrapolation cam have the effect of transforming a circular 2D feature into a toroidal 3D element, or a gently curved 2D feature into a generally sausage-shaped 3D element.

In another technique of extrapolating a 2D feature to a 3D, the detected 2D feature is extrapolated using an extrusion operation. As an example of an extrusion operation, the set of points {(x₁,y₁,z₁), (x₂,y₂,z₂) . . . (xₙ,yₙ,zₙ)} may be extrapolated to a 3D element by generating a new set of points {(x′₁,y′₁,z′₁), (x′₂,y′₂,z′₂) . . . (x′ₚ,y′ₚ,z′ₚ)} as the union of all sets {(x₁+sₓ(t),y₁+s_{y}(t),z₁+s_{z}(t)), . . . (xₙ+sₓ(t),yₙ+s_{y}(t),zₙ+s_{z}(t))} for all values of t, where s(t) is a parametric curve in three dimensions. The parametric curve s(t) (including the range of t) may be determined based on user input. For example, the user may trace a path on a touchscreen of the user device, and this path may be mapped from the two-dimensional coordinates representing the screen to three-dimensional coordinates representing the parametric curve s(t). This mapping may be different from the mapping M described above.

In a further technique of extrapolating a 2D feature to a 3D element, a lathe operation is performed. As an example of a lathe operation, the set of points { . . . (xᵢ,yᵢ,zᵢ) . . . } may be extrapolated to a 3D element by generating a new set of points { . . . (x′ⱼ,y′ⱼ,z′ⱼ) . . . } as the union of all sets { . . . (xᵢ,yᵢ,zᵢ)·R(θ) . . . }, for all values of θ, where R(θ) is a rotation matrix.

Given the above examples of extrapolating from a 2D feature to a 3D element, those of ordinary skill in the art will understand that other techniques of extrapolating 2D features to 3D elements may be used as alternatives or in addition to the techniques listed above. It may also be understood that the extrapolation techniques described herein may be implemented using techniques other than the set manipulation examples given above, which were selected for the sake of simplicity. Other techniques for extrusion, lathe, and other operations are well known in the art of, for example, computer-aided design.

In step 610, one or more generated 3D elements may be modulated by the user. For example, a user may resize the elements (e.g. with a pinch input on a touch screen of a client device), rotate the elements, and/or reposition the elements with the 3D coordinate system. A user may also initiate procedural geometry routines that operate to, for example, generate self-similar patterns from scaled copies of the generated 3D elements.

In step 612, 614, and 616, the user uploads the generated 3D content and associated data to permit viewing of the content by other users. For example, in step 612, the user uploads the reference image used in the generation of the 3D content. In step 614, the user uploads the 3D content itself, for example as a polygon mesh, as a non-uniform rational B-spline, as a face-vertex mesh, or as a set of points. In some embodiments, the user also uploads information identifying the mapping M (which, as described above, maps 2D points of the reference image to 3D points in the real environment). This information regarding the mapping M is sufficient to allow a different user with a view of the scene included in the reference image to reconstruct the 3D coordinate system. In step 616, the location at which the reference image was captured are uploaded. The location may be provided in the form of, for example, GPS coordinates.

As an alternative or in addition to uploading, the device on which the 3D content was generated may itself store and display the content as an augmented reality overlay, particularly where an augmented reality device is used for the generation of the content. In some embodiments, the user may switch the augmented reality device between a tracking mode and a non-tracking mode. In the tracking mode, the 3D geometric elements are rendered as augmented reality elements in the scene. In the non-tracking mode, the 3D geometric elements may be displayed as an overlay on the reference image. The non-tracking mode allows for authoring of the 3D content without requiring that the client device (e.g. a tablet computer) be pointed at the virtual location of the 3D elements during authoring.

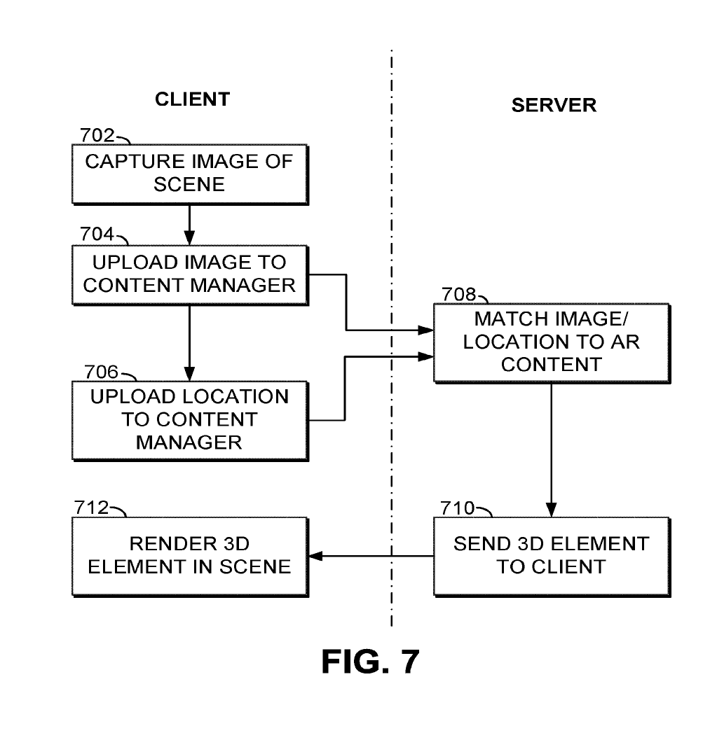

An exemplary method for viewing 3D content is illustrated in FIG. 7. In step 702, a user interested in viewing augmented reality content captures an image of a scene. In step 704, the image (referred to herein as an index image) is uploaded to a content manager. In some embodiments, in step 706, the user uploads information identifying his or her location to the content manager.

In step 708, based on the uploaded index image (and, optionally, based on the uploaded location), the content manager identifies one or more sets of 3D content. The identification of 3D content may proceed as follows in some embodiments. Based on the user location uploaded in step 706, the content manager identifies a subset one or more reference images (uploaded in step 612) that were captured in proximity to the uploaded location. Proximity may be defined as reference images within a predetermined radius, or as the N most proximate reference images, where N may be a predetermined number, among other possibilities. From within the subset of identified reference images, the content manager performs an image matching search to identify at least one reference image that matches the index image. In step 710, the content manager sends to the user one or more 3D elements that correspond to the matching reference image. In step 712, the client device of the user renders the downloaded 3D elements as augmented reality elements in the scene.

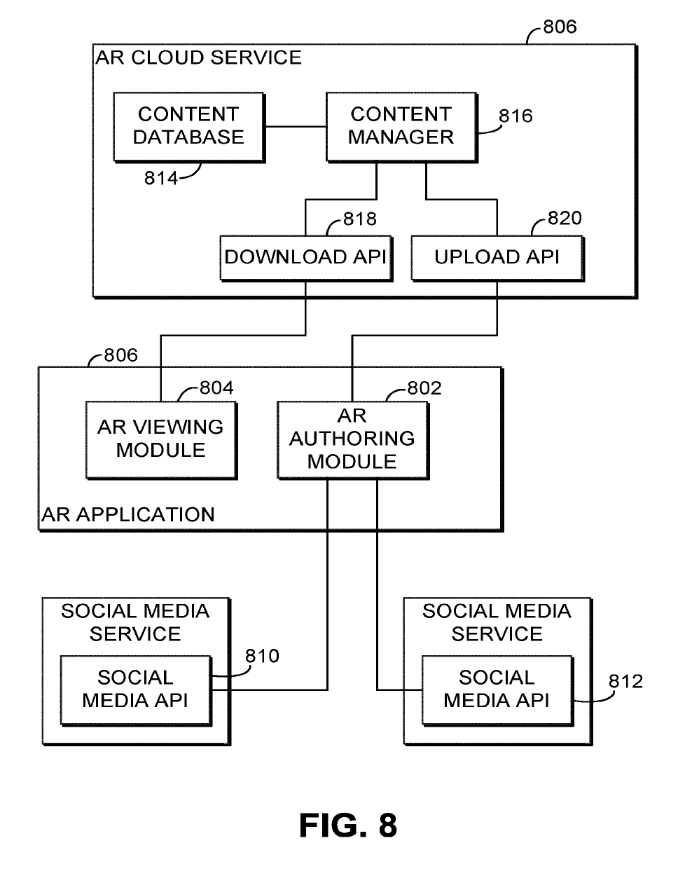

FIG. 8 is a functional block diagram of a system architecture of an AR content authoring, viewing, and distribution system according to exemplary embodiments. In some embodiments, the system provides functionalities to a user such as AR content authoring 802 and AR content viewing 804. Functionality and a user interface for both of these features may be implemented inside an AR application 806. The AR application 808 is executed on a computer system or device providing memory, communication and processing capabilities, as well as required camera, display and user input hardware. Various forms of such a device platform can be for example a personal computer, smart glass device or mobile device (smart phone/tablet computer).

FIG. 8 further illustrates an AR cloud service 808, and a plurality of social media services provided with APIs 810, 812. The AR cloud service 808 includes a content database 814 connected to a content manager 816. The content manager 816 is connected to a download API 818 and an upload API 820. The AR application includes software 802 for AR authoring and 804 for AR viewing. These software elements may be implemented as a single piece of software or may be implemented as separate pieces of software. The AR viewing software 804 is in communication with the download API 818. In this sense, the AR viewing software may be used to view AR content that is stored on the content database via the download API. The AR authoring software 802 is in communication with the upload API 820. In this sense the AR authoring software may be used to store AR content on the content database via the upload API. Of course metadata may be stored and accessed via the APIs as well. The AR authoring software can interface with various social media APIs. Generated AR content is disseminated through use of various social media channels. The AR authoring software allows users to share their content via social media channels through use of the plurality of social media APIs.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Exemplary embodiments disclosed herein are implemented using one or more wired and/or wireless network nodes, such as a wireless transmit/receive unit (WTRU) or other network entity.

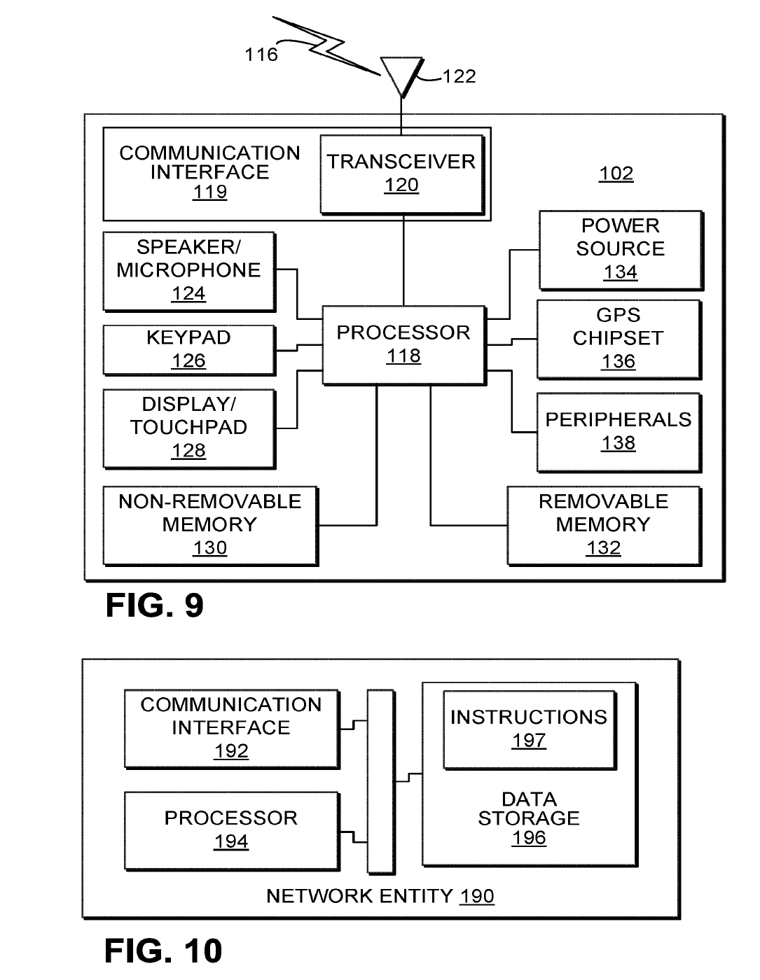

FIG. 9 is a system diagram of an exemplary WTRU 902, which may be employed as an augmented reality user device in embodiments described herein. As shown in FIG. 9, the WTRU 902 may include a processor 918, a communication interface 919 including a transceiver 920, a transmit/receive element 922, a speaker/microphone 924, a keypad 926, a display/touchpad 928, a non-removable memory 930, a removable memory 932, a power source 934, a global positioning system (GPS) chipset 936, and sensors 938. It will be appreciated that the WTRU 902 may include any sub-combination of the foregoing elements while remaining consistent with an embodiment.

The processor 918 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 918 may perform signal coding, data processing, power control, input/output processing, and/or any other functionality that enables the WTRU 902 to operate in a wireless environment. The processor 918 may be coupled to the transceiver 920, which may be coupled to the transmit/receive element 922. While FIG. 9 depicts the processor 918 and the transceiver 920 as separate components, it will be appreciated that the processor 918 and the transceiver 920 may be integrated together in an electronic package or chip.

The transmit/receive element 922 may be configured to transmit signals to, or receive signals from, a base station over the air interface 916. For example, in one embodiment, the transmit/receive element 922 may be an antenna configured to transmit and/or receive RF signals. In another embodiment, the transmit/receive element 922 may be an emitter/detector configured to transmit and/or receive IR, UV, or visible light signals, as examples. In yet another embodiment, the transmit/receive element 922 may be configured to transmit and receive both RF and light signals. It will be appreciated that the transmit/receive element 922 may be configured to transmit and/or receive any combination of wireless signals.

In addition, although the transmit/receive element 922 is depicted in FIG. 9 as a single element, the WTRU 902 may include any number of transmit/receive elements 922. More specifically, the WTRU 902 may employ MIMO technology. Thus, in one embodiment, the WTRU 902 may include two or more transmit/receive elements 922 (e.g., multiple antennas) for transmitting and receiving wireless signals over the air interface 916.

The transceiver 920 may be configured to modulate the signals that are to be transmitted by the transmit/receive element 922 and to demodulate the signals that are received by the transmit/receive element 922. As noted above, the WTRU 902 may have multi-mode capabilities. Thus, the transceiver 920 may include multiple transceivers for enabling the WTRU 902 to communicate via multiple RATs, such as UTRA and IEEE 802.11, as examples.

The processor 918 of the WTRU 902 may be coupled to, and may receive user input data from, the speaker/microphone 924, the keypad 926, and/or the display/touchpad 928 (e.g., a liquid crystal display (LCD) display unit or organic light-emitting diode (OLED) display unit). The processor 918 may also output user data to the speaker/microphone 924, the keypad 926, and/or the display/touchpad 928. In addition, the processor 918 may access information from, and store data in, any type of suitable memory, such as the non-removable memory 130 and/or the removable memory 132. The non-removable memory 930 may include random-access memory (RAM), read-only memory (ROM), a hard disk, or any other type of memory storage device. The removable memory 932 may include a subscriber identity module (SIM) card, a memory stick, a secure digital (SD) memory card, and the like. In other embodiments, the processor 918 may access information from, and store data in, memory that is not physically located on the WTRU 902, such as on a server or a home computer (not shown).

The processor 918 may receive power from the power source 934, and may be configured to distribute and/or control the power to the other components in the WTRU 902. The power source 934 may be any suitable device for powering the WTRU 902. As examples, the power source 934 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

The processor 918 may also be coupled to the GPS chipset 936, which may be configured to provide location information (e.g., longitude and latitude) regarding the current location of the WTRU 902. In addition to, or in lieu of, the information from the GPS chipset 936, the WTRU 902 may receive location information over the air interface 916 from a base station and/or determine its location based on the timing of the signals being received from two or more nearby base stations. It will be appreciated that the WTRU 902 may acquire location information by way of any suitable location-determination method while remaining consistent with an embodiment.

The processor 918 may further be coupled to other peripherals 938, which may include one or more software and/or hardware modules that provide additional features, functionality and/or wired or wireless connectivity. For example, the peripherals 938 may include sensors such as an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 10 depicts an exemplary network entity 1090 that may be used in embodiments of the present disclosure, for example as a content manager. As depicted in FIG. 10, network entity 1090 includes a communication interface 1092, a processor 1094, and non-transitory data storage 1096, all of which are communicatively linked by a bus, network, or other communication path 1098.

Communication interface 1092 may include one or more wired communication interfaces and/or one or more wireless-communication interfaces. With respect to wired communication, communication interface 1092 may include one or more interfaces such as Ethernet interfaces, as an example. With respect to wireless communication, communication interface 1092 may include components such as one or more antennae, one or more transceivers/chipsets designed and configured for one or more types of wireless (e.g., LTE) communication, and/or any other components deemed suitable by those of skill in the relevant art. And further with respect to wireless communication, communication interface 1092 may be equipped at a scale and with a configuration appropriate for acting on the network side—as opposed to the client side—of wireless communications (e.g., LTE communications, Wi-Fi communications, and the like). Thus, communication interface 1092 may include the appropriate equipment and circuitry (perhaps including multiple transceivers) for serving multiple mobile stations, UEs, or other access terminals in a coverage area.

Processor 1094 may include one or more processors of any type deemed suitable by those of skill in the relevant art, some examples including a general-purpose microprocessor and a dedicated DSP.

Data storage 1096 may take the form of any non-transitory computer-readable medium or combination of such media, some examples including flash memory, read-only memory (ROM), and random-access memory (RAM) to name but a few, as any one or more types of non-transitory data storage deemed suitable by those of skill in the relevant art could be used. As depicted in FIG. 10, data storage 1096 contains program instructions 1097 executable by processor 1094 for carrying out various combinations of the various network-entity functions described herein.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

1. A method comprising:
operating a camera to capture a reference image of a scene in a user's environment;
automatically identifying at least one 2D geometric feature in the reference image of the user's environment;
receiving a user selection of at least one of the automatically identified 2D geometric features;
generating a 3D geometric element by extrapolating the selected 2D feature into three dimensions; and
displaying the 3D geometric element as an augmented reality overlay on the captured scene in the user's environment and extrapolated from the selected 2D feature.

2. The method of claim 1, wherein automatically identifying at least one 2D geometric feature includes performing edge detection.

3. The method of claim 1, wherein extrapolating the 2D feature includes performing a lathe operation.

4. The method of claim 1, wherein extrapolating the 2D feature includes performing an extrusion operation.

5. The method of claim 1, wherein the extrapolation of the 2D feature into three dimensions is performed in response to user input.

6. The method of claim 5, wherein the user input is a gesture input.

7. The method of claim 5, wherein the user input is a touch screen input.

8. The method of claim 1, further comprising modulating the generated 3D geometric element.

9. The method of claim 8, wherein modulating the generated 3D geometric element includes resizing the 3D geometric element in response to user input.

10. A method performed at a first user device, the method comprising:
capturing a reference image of a scene in a user's environment;
automatically identifying at least one 2D geometric feature in the reference image;
receiving a user selection of at least one of the automatically identified 2D geometric features;
generating a 3D geometric element by extrapolating the selected 2D feature into three dimensions; and
transmitting the generated 3D geometric element and the reference image to a content manager.

11. The method of claim 10, further comprising:
determining a location at which the reference image was captured; and
transmitting the determined location to the content manager.

12. The method of claim 11, further comprising, at a second user device:
capturing an index image of a scene;
determining a location of the second user device;
downloading at least one 3D geometric element corresponding to the index image and the determined location; and
rendering the at least one 3D geometric element as an augmented reality overlay on the scene.

13. The method of claim 10, further comprising, at a second user device:
capturing an index image of a scene;
downloading at least one 3D geometric element corresponding to the index image;
and rendering the at least one 3D geometric element as an augmented reality overlay on the scene.

14. The method of claim 10, wherein automatically identifying at least one 2D geometric feature includes performing edge detection.

15. The method of claim 10, wherein extrapolating the 2D feature includes performing a lathe operation.

16. The method of claim 10, wherein extrapolating the 2D feature includes performing an extrusion operation.

17. The method of claim 10, wherein the extrapolation of the 2D feature into three dimensions is performed in response to user input.

18. The method of claim 17, wherein the user input is a gesture input.

19. The method of claim 17, wherein the user input is a touch screen input.

20. An augmented reality device comprising a processor, a camera, a display, and a non-transitory computer storage medium operative storing instructions operative, when executed on the processor, to perform functions including:
operating a camera to capture a reference image of a scene in a user's environment;
automatically identifying at least one 2D geometric feature in the reference image of the user's environment;
receiving a user selection of at least one of the automatically identified 2D geometric features;
generating a 3D geometric element by extrapolating the selected 2D feature into three dimensions; and
displaying the 3D geometric element as an augmented reality overlay on the captured scene in the user's environment and extrapolated from the selected 2D feature.
